(19) United States
(12) Patent Application Publication
(10) Pub. No.: US 2009/0319893 A1
(43) Pub. Date: Dec. 24, 2009

(54) Method and Apparatus for Assigning a Tactile Cue

(75) Inventor: Pekka Juhana Pihlaja, Hevonpaa (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/145,217

(22) Filed: Jun. 24, 2008

(51) Int. Cl. G06F 3/01

(52) U.S. Cl. 715/702

(57) ABSTRACT

In accordance with an example embodiment of the present invention, an electronic device is configured to allow selection of a feature to be associated with a tactile cue. The electronic device is also configured to detect an action for the selection of the feature. The electronic device is configured to assign the action to the feature.

### RELATED APPLICATIONS

This application relates to U.S. Application No. 2008/0010593, titled “USER INTERFACE INPUT DEVICE”, filed Jun. 30, 2006, which is hereby incorporated by reference in its entirety and U.S. Patent Application, titled “METHOD AND APPARATUS FOR EXECUTING A FEATURE USING A TACTILE CUE”, being concurrently filed, which is hereby incorporated by reference in its entirety.

### TECHNICAL FIELD

The present application relates generally to electronic device user interfaces.

### BACKGROUND

User interfaces have become commonplace since the emergence of the electronic interface. Electronic interfaces have become familiar in retail settings, on point of sale systems, on smart phones, on Automated Teller Machines (ATMs) and on Personal Digital Assistant (PDAs). The popularity of smart phones, PDAs, and many types of information appliances is growing the demand for, and the acceptance of, these electronic interfaces. Although the demand and acceptance for electronic interfaces is growing, features are still limited.

### SUMMARY

Various aspects of the invention are set out in the claims.

In accordance with an example embodiment of the present invention, an electronic device is configured to allow selection of a feature to be associated with a tactile cue. The electronic device is also configured to detect an action for the selection of the feature. The electronic device is configured to assign the action to the feature.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2A is a block diagram depicting an electronic device receiving a tactile cue in a user preferred location according to an example embodiment of the invention;

FIG. 2B is a block diagram depicting a user's sweeping finger moving upwards on a screen to facilitate execution of a feature on an electronic device according to an example embodiment of the invention;

FIG. 3 is a block diagram depicting an electronic device receiving a tactile cue in a user preferred location according to another example embodiment of the invention;

FIG. 4 is a block diagram depicting a radio-frequency identifier tag within a tactile cue communicating with a radio-frequency identifier antenna of an electronic device according to an example embodiment of the invention;

FIG. 5 is a block diagram depicting a replaceable cover for an electronic device according to an example embodiment of the invention; and

FIG. 6 is a flow diagram illustrating a process for assigning an action to a feature according to an example embodiment of the invention.

### DETAILED DESCRIPTION OF THE DRAWINGS

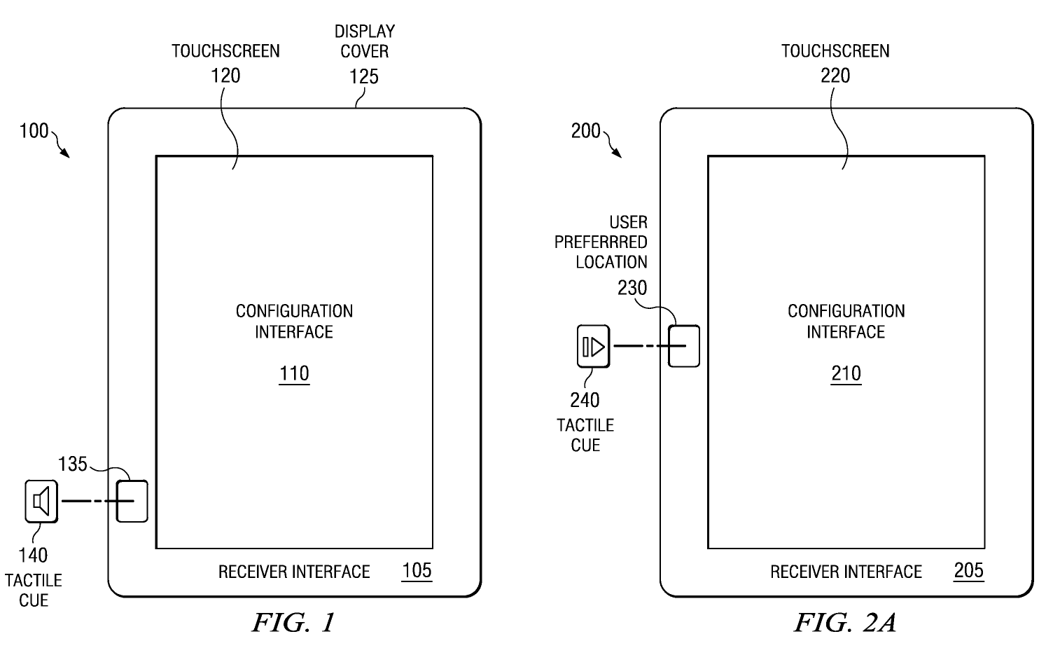

An example embodiment of the present invention and its potential advantages are best understood by referring to FIGS. 1 through 6 of the drawings.

Traditional screens, such as a touchscreen, provide a user with soft keys and other soft input devices on a user interface. But soft keys and soft input devices are of limited use. In particular, the soft keys and soft input devices do not provide users with tactile cues of use without visual inspection, e.g., eyes-free use. Using a touchscreen without visual inspection is desirable for features, such as music playback, volume control, Global Positioning System (GPS) navigation and/or the like. Example embodiments of the invention use tactile cues to facilitate execution of a feature on a touchscreen, display cover, or electronic device.

FIG. 1 is a block diagram depicting an electronic device 100 operating in accordance with an example embodiment of the invention. The electronic device 100, e.g., a mobile device, is configured to communicate in a wireless network. The wireless network may be a Wireless Personal Area Network (WPAN) operating, for example, under the Bluetooth or IEEE 802.15 network protocol. The wireless network may also be a Wireless Local Area Network (WLAN) operating, for example under the IEEE 802.11, Hiperlan, WiMedia Ultra Wide Band (UWB), WiMax, WiFi, Digital Enhanced Cordless Telecommunications (DECT) and/or similar network protocols. The wireless network may be a wireless wide area network (WWAN) operating, for example, under a cellular telephone network protocol, for example Global System for Mobile (GSM), General Packet Radio Service (GPRS), Enhanced Data rates for GSM Evolution (EDGE), Code Division Multiple Access (CDMA), Universal Mobile Telecommunications System (UMTS), CDMA2000, and/or the like. It is possible for each of these wireless network protocols to be capable to communicate with the electronic device 100. These wireless network protocols are not meant to be limiting, since it is common for wireless communications protocols to provide for communication between mobile wireless devices and/or on a wired network infrastructure via wireless access points.

In an example embodiment, the electronic device 100 comprises a touchscreen 120, a configuration interface 110, and a display cover 125. In the example embodiment, the display cover 125 comprises a receiver interface 105. The receiver interface 105 is configured to receive a tactile cue 140, such as volume control or the like. For example, a user may place a tactile cue 140 in a preferred location, such as location 135, on the receiver interface 105. In an embodiment, the receiver interface 105 may be located on a portion of a display cover 125 as shown at the location 135. In an alternative embodiment, the receiver interface 105 may be located on the full display cover 125.

Once the receiver interface 105 receives a tactile cue 140, the electronic device 100 allows a user to assign an action to associate with the tactile cue and the feature. For example, the electronic device 100 uses configuration interface 110, which is configured to allow selection of a feature to be associated with the tactile cue 140. For example, a user places the tactile cue 140 over the receiver interface 105 and the configuration interface 110 provides the user a feature list, e.g., volume control, playback, and/or the like, for selection. The user may select a feature, such as volume control.

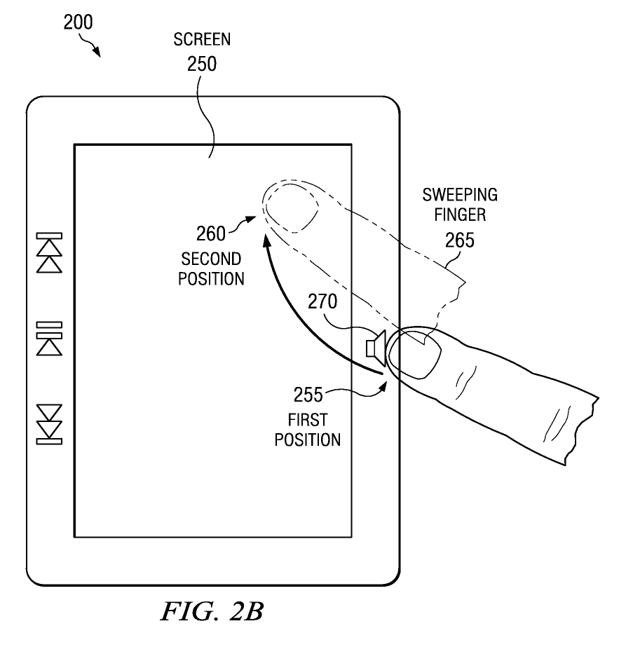

The configuration interface 110 is configured to detect an action for the feature selection. For example, configuration interface 110 detects the user action, such as a sweep, beginning at the received tactile cue 140 as a starting point on the touchscreen 120 to indicate, for example, a volume control change. After the configuration interface 110 detects the action for the feature selection, the configuration interface 110 assigns the sweep action to the volume control feature. Restated, the configuration interface 110 is configured to assign the action to the feature. The user may execute the feature by performing the action for the feature, e.g., increase volume and the electronic device 100 increases the volume. That is, the user, using the tactile cue 140 as a starting point, performs a sweep, e.g., the assigned action, to adjust the volume as shown in FIG. 2B. It is useful to note that the user may replace an existing tactile cue or add additional tactile cues to obtain a desirable interface.

It should be understood that the tactile cue 140 may be arranged in a pattern of a predetermined number of raised lines. In an alternative embodiment, the tactile cue may use a shape, other identifiable symbol and/or the like. Thus, the tactile cue distinguishes from another by the pattern of raised lines, the shape, identifiable symbol, and/or the like. In an alternative embodiment, the tactile cues may be an indicator of a starting location or point on a screen to facilitate execution of a feature using a finger sweep, roll, gesture, and/or the like. In an embodiment, a sweep may move or carry a finger on the touchscreen 120. In an embodiment, a roll may move by turning on an axis on touchscreen 120. In an embodiment, a gesture may make a sign or motion, such as an “x.” It should be understood that the above is merely an example and sweep, roll, and gesture may comprise many different forms and variations as known in the art.

It should also be understood that while an electronic device 100 is shown in the drawings and will be used in describing example embodiments of the invention, the invention has application to the entire gamut of consumer electronics including, but not limited to, a mobile telephone, a personal digital assistant, a portable computer device, GPS, a mobile computer, a camera, a browsing device, an electronic book reader, a combination thereof, and/or the like. Further still, example embodiments of the invention may also be applicable to a touchscreen, a screen, a screen edge, a display cover, a touch pad, or a combination thereof.

It should be further understood that the tactile cue 140 may be positioned on a touchscreen, on a screen, on a screen edge, on a display cover, adjacent to a screen, or a combination thereof. It should be further understood that the tactile cue 140 may be concave, convex, embossed icon, a replaceable sticker, three dimensional and/or the like. In an embodiment, the tactile cue 140 may be opaque, transparent, and/or the like.

Moreover, in an example embodiment, the electronic device 100 may use one of many touch sensor technologies. For example, the electronic device 100 may use a capacitive touch sensor, e.g., an analog capacitive sensor or a projected capacitive sensor, a resistive touch sensor, an optical touch sensor, an acoustic touch sensor, a force sensor, a vibration touch sensor, or any other suitable touch sensor. Use of other touch sensor technologies is also possible.

In an alternative embodiment, the electronic device 100 uses piezo actuator, which comprises a piezo element to generate an electrical signal in response to physical pressure, e.g., haptic feedback, such as the force exerted by placing the tactile cue 140 in place. It should be understood that both the piezo sensors and the piezo actuator may be fabricated from a single piezo-electric element so as to be both coplanar and electronically isolated from one another. The difference in operation between the piezo sensors and the piezo actuator is achieved through a coupling of the piezo sensors and the piezo actuator to a voltage source and a differential voltage measurement device respectively as known in the art. Other configurations are also possible.

FIG. 2A is a block diagram depicting an electronic device 200 receiving a tactile cue 240 in a user preferred location 230 according to an example embodiment of the invention. In an example embodiment, the electronic device 200 comprises a touchscreen 220, a receiver interface 205, and a configuration interface 210. The receiver interface 205 is configured to receive a tactile cue 240, such as a playback button. In an embodiment, the receiver interface 205 is further configured to receive the tactile cue 240 in a user preferred location 230. That is, the receiver interface 205 allows a user to place the tactile cue 240 in any user preferred location, such as user preferred location 230.

In an embodiment, the receiver interface 205 is configured to receive a clip with the tactile cue 240. Using at least in part the clip, the tactile cue 240 is affixed to the receiver interface 205. In an alternative embodiment, the receiver interface 205 is configured to receive the tactile cue 240 with adhesive. Using at least in part the adhesive, the tactile cue 240 is affixed to the receiver interface 205. For example, the user may use a replaceable or permanent sticker tactile cue 240 with an adhesive to affix the tactile cue 240. Alternatively, the user may use a clip to affix or otherwise place the tactile cue 240 to the receiver interface 205. Other techniques for affixing the tactile cue 240 to the receiver interface 205 are also possible. In an embodiment, the configuration interface 210 is configured to assign the action to the feature in accordance with example embodiments of the invention. As a result, a user may use the tactile cue 240 for executing features at the preferred location 230 by affixing the tactile cue 240 with an adhesive or clip.

FIG. 2B is a block diagram depicting a user's sweeping finger 265 moving upwards on a screen 250 to execute a feature, e.g., change volume, on an electronic device 200 according to an example embodiment of the invention. In this example embodiment, a tactile cue 270, which is assigned to a feature, is used by a user. For example, the user's sweeping finger 265 moves from a first position 255, located approximately at the tactile cue 270, towards a second position 260. That is, the user's sweeping finger 265 moves from a volume control representation, e.g., tactile cue 270, at the first position 255 upwards towards the second position 260. In an example embodiment, the electronic device 200, as described above, may process the movement, associate the movement with volume control, and adjust the volume on the electronic device 200. At no point does the user need to look at the electronic device 200, but rather the user may use the tactile cue 270 to facilitate execution of the feature via a finger touch or sweep. Thus, the user adjusts the electronic device 200 volume.

It should be further understood that the user may adjust the volume or other electronic device 200 features by sweeping in a known direction and the upward/downward sweeping is merely for illustrative purposes. For example, the same sweeping motion for volume control may also be used to allow the user to adjust the screen 250 by zooming in or out. Many other feature configurations are also possible. It should be further understood that the user is not limited to moving in a sweeping motion. But rather, the user may also make a gesture, such as the letter “X” to indicate closing a program or window. Other variations are also possible.

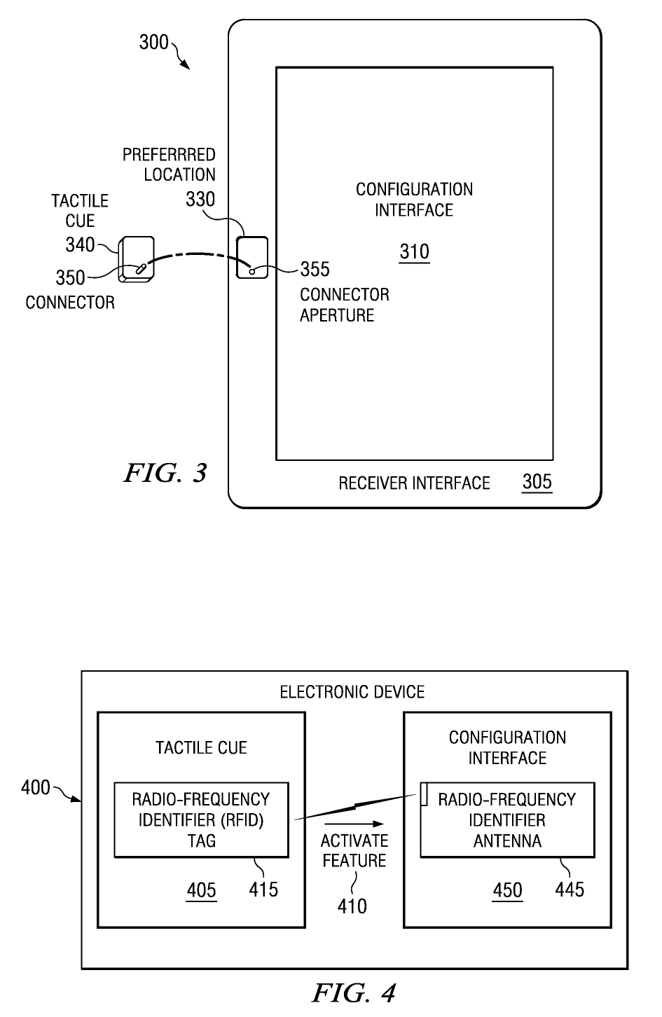

FIG. 3 is a block diagram depicting an electronic device 300 receiving a tactile cue 340 in a user preferred location according to another example embodiment of the invention. In an example embodiment, the electronic device 300 comprises a receiver interface 305 having a connector aperture 355 and a configuration interface 310. The receiver interface 305 is configured to receive the connector 350 to affix the tactile cue 340 using, for example, the connector aperture 355. As a result, a user may affix the tactile cue 340 into the receiver interface 305. Moreover, the receiver interface 305 is configured to activate the tactile cue 340 by way of an electric connection between the electronic device 300 and the tactile cue 340. By using the electric connection, the tactile cue 340 becomes operable. It should be understood that any number of connectors and/or connector apertures may be used.

In an example embodiment, the connector 350 is a conductive device for joining electrical circuits together. Further, an electrical connection may be temporary, as for portable equipment, or may use a tool for assembly and removal, or may be a permanent electrical joint between two wires or devices. Many different electrical connector configurations are possible. For example, the connector 350 may be a plug connector and the connector aperture 355 may be a socket connector. Plug and socket connectors are typically made up of a male plug and a female socket, although hermaphroditic connectors exist and may be employed. Plugs generally have one or more pins or prongs that are inserted into openings in the mating socket. The connection between the mating metal parts must be sufficiently tight to make a good electrical connection and complete the circuit.

It is useful to note that electrical and electronic components and devices may include plug and socket connectors, but individual screw terminals and fast-on or quick-disconnect terminals are also possible.

Referring back now to FIG. 3, once the receiver interface 305 receives a tactile cue 340 and an electrical connection is established, the configuration interface 310 assigns the action to the feature in accordance with example embodiments of the invention. As a result, a user may use the tactile cue 340 for executing features at a preferred location 330.

FIG. 4 is a block diagram depicting a radio-frequency identifier (RFID) tag 415 within a tactile cue 405 communicating with a radio-frequency identifier antenna 445 of an electronic device 400 according to an example embodiment of the invention. A user may place the tactile cue 405 on the electronic device 400, e.g., on the receiver interface. The RFID tag 415 may broadcast at least one instruction to the RFID antenna 445 in a configuration interface 450. The at least one instruction indicates the presence of the tactile cue 405. The configuration interface 110 is configured to provide a feature list to the user, detects a user action, and/or assigns the action to the feature as described above. In this way, the RFID tag 415 may be used to activate a feature for the tactile cue 405.

In an example embodiment, the RFID tag 415 is an active RFID tag using an internal battery for power. An active tag, for example, may use its battery to broadcast radio waves to the RFID antenna 445 on a high frequency, such as between 850 to 950 MHz. In an alternative embodiment, the RFID antenna 445 may transmit according to RFID communication bands, such as, “RFID LF (0.125-0.134 MHz); RFID HF (13.56-13.56 MHz); RFID UHF (433 MHz, 865-956 MHz, 2450 MHz).” In an example embodiment, the RFID tag 415 may also include a replaceable battery or a non-replaceable battery in a sealed configuration interface 110. In an alternative embodiment, the RFID tag 415 is a passive RFID tag, which relies on the electronic device 400 for power.

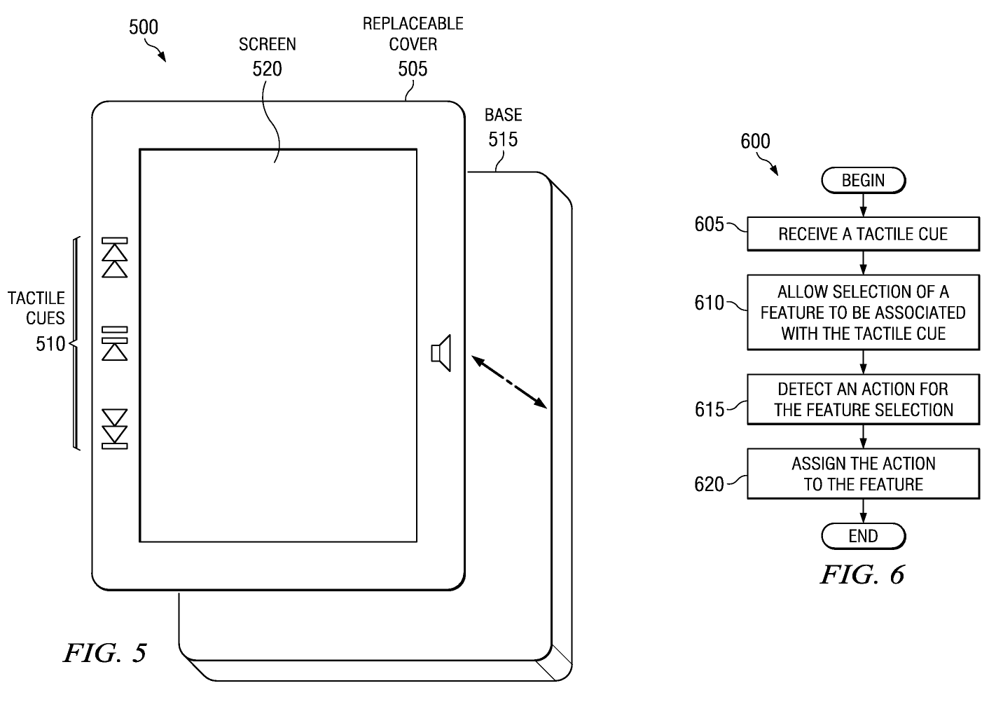

FIG. 5 is a block diagram depicting an electronic device 500 comprising a replaceable cover 505 according to an example embodiment of the invention. The electronic device 500 comprises a screen 520, a base 515, and a replaceable cover 505 having tactile cues 510. In an example embodiment, the replaceable cover 505 of the electronic device 500 is coupled or otherwise affixed to the screen 520 thereby providing tactile cues 510 to a user. The tactile cues 510 may be comprised of many types of materials. Some examples include using at least one of the following materials: rubber, leather, plastic, metal, or a combination thereof.

In use, a display cover of the electronic device's 500, such as replaceable cover 505, may be removed and replaced by a user. In particular, the replaceable cover 505 of the electronic device 500 may be removed from the base 515. A new cover may then be installed. By replacing the replaceable cover 505, custom configurations of tactile cues 510 may be performed. That is, a user may have one replaceable cover 505 for work (e.g., work related tactile cues 510) and another replaceable cover 505 for home (e.g., entertainment tactile cues 510). It should be understood that the replaceable cover 505 or new cover may be fastened together by any technique known in the art to securely enclose the internal workings of an electronic device 500. It should be further understood that the replaceable cover 505 may be made of any suitable material known in the art.

In an embodiment, the electronic device 500 may not include a screen 520, but rather comprise a replaceable cover 505 configured to conform to the dimensions of the base 515. The replaceable cover 505 may be manufactured from injection molding and/or vacuum molded plastic, or other like suitable material having sufficient rigidity. The replaceable cover 505 may be a single unit, thus making it easy to remove, replace, and reuse as the user desires. The replaceable cover 505 may also include stencil or silk screening to identify the numbers and tactile cues 510 or function keys in any language, and thus reduce the cost of having to produce phone or pager units with different languages. The replaceable cover 505 may be stenciled, embossed, or silk screened as desired with any tactile cues 510 or logo. For example, the tactile cues 510 may resemble normal mechanical keys with key graphics. The tactile cues 510 may be concave, convex or flat. Further, the tactile cues 510 may use different materials, e.g. rubber or leather patches on a plastic or a metal cover. In an embodiment, the tactile cues 510 can be flat and coupled to the replaceable cover 505 without indication. Therefore, the tactile cues 510 are distinguished from the replaceable cover 505 by the material or texture of the tactile cues 510. In an example embodiment, the tactile cues 510 may also be dynamic (e.g., tactile cues 510 appear and disappear) using an actuator, such as a mechanical actuator. All figures are illustrative.

FIG. 6 is a flow diagram illustrating an example process 600 for assigning an action to a feature according to an example embodiment of the invention. An electronic device is configured to apply the example process 600 and receive a tactile cue at 605. In an embodiment, the electronic device may use a receiver interface, such as receiver interface 105 of FIG. 1. For example, a user may affix a volume button having a tactile cue in the receiver interface of the electronic device. At 610, the electronic device may include a configuration interface, which is configured to allow selection of a feature to be associated with the tactile cue. A user, for example, selects a volume control feature from the configuration interface of the electronic device. At 615, the configuration interface is configured to detect an action for the feature selection. For example, the configuration interface detects a user action, such as a sweep or other gesture. At 620, the configuration interface is configured to assign the action to the feature. For example, the configuration interface assigns the sweep or other gesture to the volume control feature. Thus, the action, such as a sweep or gesture, is assigned to the tactile cue. A user may use the action to perform the feature assigned to the tactile cue. For example, a user may sweep to use the volume control feature. It should be understood that for certain features multiple actions may be used, for example, sweeping upwards to increase the volume and sweeping downwards to decrease the volume.

Without in any way limiting the scope, interpretation, or application of the claims appearing below, it is possible that a technical effect of one or more of the example embodiments disclosed herein may be personalizing a location for a tactile cue. Another possible technical effect of one or more of the example embodiments disclosed herein may be providing many configurations for the same electronic device using tactile cues. Another technical effect of one or more of the example embodiments disclosed herein may be flexibility with setup of an electronic device.

Embodiments of the present invention may be implemented in software, hardware, application logic or a combination of software, hardware and application logic. The software, application logic and/or hardware may reside on a mobile phone, personal digital assistant or other electronic device. If desired, part of the software, application logic and/or hardware may reside on an electronic device, part of the software, application logic and/or hardware may reside in memory. The application logic, software or an instruction set is preferably maintained on any one of various conventional computer-readable media. In the context of this document, a “computer-readable medium” may be any media or means that may contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a configuration interface configured to:
allow selection of a feature to be associated a the tactile cue;
detect an action for the selection of the feature; and
assign the action to the feature.

2. The apparatus of claim 1 further comprising:
a receiver interface configured to receive the tactile cue.

3. The apparatus of claim 2 wherein the receiver interface is further configured to receive the tactile cue in a user preferred location.

4. The apparatus of claim 2 wherein the receiver interface is further configured to allow the tactile cue to be affixed using a clip or adhesive.

5. The apparatus of claim 2 wherein the receiver interface is further configured to receive a connector to affix the tactile cue to the apparatus.

6. The apparatus of claim 2 wherein the receiver interface is further configured to activate the tactile cue by way of an electric connection between the apparatus and the tactile cue.

7. The apparatus of claim 2 wherein the receiver interface comprises a display cover.

8. The apparatus of claim 2 wherein the display cover is replaceable.

9. The apparatus of claim 7 wherein the display cover is replaceable.

10. The apparatus of claim 1 further comprising a tactile cue, wherein the tactile cue is concave, convex, embossed icon, opaque, transparent, a sticker, or three-dimensional.

11. The apparatus of claim 1 further comprising a tactile cue, wherein the tactile cue comprises at least one of the following: rubber, leather, plastic, metal, or a combination thereof.

12. The apparatus of claim 1 further comprising a tactile cue, wherein the tactile cue is a replaceable sticker.

13. The apparatus of claim 1 wherein the apparatus further comprises:
a radio-frequency identifier antenna of the configuration interface and a radio-frequency identifier tag of a tactile cue configured to communicate.

14. The apparatus of claim 1 wherein the action is a sweep, roll, or gesture.

15. The apparatus of claim 1 wherein the feature comprises at least one of the following: volume, graphical user interface menu, or at least one playback feature.

16. A method, comprising:
allowing selection of a feature to be associated with a tactile cue;
detecting an action for the selection of the feature; and
assigning the action to the feature.

17. The method of claim 16 further comprising:
receiving the tactile cue.

18. The method of claim 17 wherein receiving the tactile cue further comprises:
receiving the tactile cue with a clip, an adhesive, or a connector.

19. The method of claim 17 further comprising:
activating the tactile cue, via an electric connection, using the connector.

20. The method of claim 17 wherein receiving the tactile cue further comprises receiving the tactile cue in a user preferred location.

21. The method of claim 16 wherein the tactile cue is concave, convex, embossed icon, opaque, transparent, a sticker, or three-dimensional.

22. The method of claim 16 wherein the tactile cue comprises at least one of the following: rubber, leather, plastic, metal, or a combination thereof.

23. The method of claim 16 wherein the tactile cue is a replaceable.

24. The method of claim 16 wherein receiving the tactile cue further comprises:
communicating between a radio-frequency identifier antenna and a radio-frequency identifier tag.

25. The method of claim 16 wherein the action is a sweep, roll, or gesture.

26. The method of claim 16 wherein the feature comprises at least one of the following: volume, graphical user interface menu, or at least one playback feature.

27. A tactile cue configured to be affixed to an apparatus.

28. A computer program product comprising a computer-readable medium bearing computer program code embodied therein for use with a computer, the computer program code comprising:
code for allowing selection of a feature to be associated with a tactile cue; code for detecting an action for the selection of the feature; and
code for assigning the action to the feature.

29. A computer-readable medium encoded with instructions that, when executed by a computer, perform:
allowing selection of a feature to be associated with a tactile cue;
detecting an action for the selection of the feature; and
assigning the action to the feature.
